(19) United States
(12) Patent Application Publication
(10) Pub. No.: US 2014/0323217 A1
(43) Pub. Date: Oct. 30, 2014

(54) METHOD AND SERVER FOR PROVIDING ITEM ACCORDING TO JOINING AN EVENT IN ONLINE GAME

(71) Applicant: Intellectual Discovery Co., Ltd., Seoul (KR)

(72) Inventors: Jeong Hun Kim, Seoul (KR); Tae Soo Park, Seoul (KR)

(73) Assignee: INTELLECTUAL DISCOVERY CO., LTD., Seoul (KR)

(21) Appl. No.: 14/364,012

(22) PCT Filed: Nov. 26, 2012
(86) PCT No.: PCT/KR2012/010035

§ 371 Date: Jun. 9, 2014

(30) Foreign Application Priority Data
Dec. 8, 2011 (KR) 10-2011-0131179

(51) Int. Cl. A63F 13/30

(52) U.S. Cl. CPC A63F 13/12
USPC 463/31; 463/42

(57) ABSTRACT

The present invention relates to a technique of providing an item when executing a certain action generating an event in an online game and required in an event. An item providing method according to event joining in an online game according to an exemplary embodiment of the present invention through a game management server includes: increasing joining number information of the event by determining whether the event is achieved according to an action related to a game play of a user during a predetermined event execution period when the user executes a predetermined action satisfying a condition achieving the event; and providing a reward item when accumulated event joining number information of the user is predetermined event finishing number information.

### TECHNICAL FIELD

The present invention relates to an item providing method according to joining an event in an online game providing an item when generating the event in the online game and performing a certain action required in the event, and a server using the same.

### BACKGROUND ART

Recently, as a network technique and a contents technique have been developed, a number of users using the online game has suddenly increased. As the utilization of online games increases, various game plays are possible through a competition and cooperation between users, and accordingly, the online game becomes contents capable of building social networks over a dimension of the simple game.

Generally, paid or free online games provided on an Internet are provided in various genres such as a simulation game, a role playing game, a mug game, and a shutting game, and a gamer in a process in which the game is performed may remove an object or may obtain an item, and a point, a level, and an experience value are stimulated and obtained.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention provides a method for providing a giveaway inducing a game joining of a user by providing an item when executing a certain action required in an event in an online game and a server thereof.

### Technical Solution

An item providing method according to event joining in an online game according to an exemplary embodiment of the present invention through a game management server includes: increasing joining number information of the event by determining whether the event is achieved according to an action related to game play of a user during a predetermined event execution period when the user executes a predetermined action satisfying a condition achieving the event; and providing a reward item when accumulated event joining number information of the user is predetermined event finishing number information.

The increasing of the event joining number information increases different event joining number information according to a kind of the event.

The kind of the event may be at least one among an attendance event increasing the event joining number information if the user accesses the game screen, a single play mode event increasing the event joining number information when a single play mode in which a team operated by the user plays at least one opposing team operated with artificial intelligence of a computer is normally finished, or a multi-play mode event increasing the event joining number information when the multi-play mode in which the team operated by the user plays at least one opposing team operated by other users is normally finished.

The increasing of the event joining number information maintains the event joining number information in one case among a case that the game result screen is not output, a case that any one user finishes the game in the games, and a case that a network access of any one user is finished in the game when executing the single play mode event or the multi-play mode event.

The increasing of the event joining number information includes: outputting the event joining number information to the user terminal when the user executes the predetermined action; and increasing the event joining number information when receiving a selection input for a region in which the event joining number information is displayed from the user terminal.

The method further includes, after providing the reward item, initializing the event joining number information of the user.

The method further includes initializing the event joining number information of the user by searching the accumulated event joining number information of the user when the event joining number information increasing amount to be achieved by the user within the remaining event execution period is smaller than the predetermined event finishing number information.

The method further includes, before increasing the event joining number information, extracting the event joining number information of the user by searching the information of the user when the user accesses the game.

The method further include, before increasing the event joining number information, outputting at least one of information of the event joined by the user and the event joining number information of the user to the user terminal of the user.

An item providing server according to event joining in an online game according to an exemplary embodiment of the present invention includes: an event generating module generating the event providing and rewarding an item if a predetermined action is executed according to an action related to a game play of the user; an event joining number information generating module generating a kind of the event joined by the user and the event joining number information of the user; and a management module determining the event achieving existence according to an action related to a game play of the user within an execution period of the predetermined event to increase the event joining number information when the user executes a predetermined action satisfying the condition achieving the event, and to provide a reward item when the accumulated event joining number information of the user is the same as predetermined event finishing number information.

event generating module generates any one among an attendance event increasing the event joining number information if the user accesses the game screen, a single play mode event increasing the event joining number information when the single play mode in which a team operated by the user plays at least one opposing team operated with artificial intelligence of a computer is normally finished, or the multi-play mode event increasing the event joining number information when the multi-play mode in which the team operated by the user plays at least one opposing team operated by other users is normally finished.

The event joining number information generating module outputs a different event joining number information according to a kind of the event.

The management module initializes the event joining number information of the user after providing the reward item.

The management module initializes the event joining number information of the user by searching the accumulated event joining number information of the user when the event joining number information increasing amount to be achieved by the user within the remaining event execution period is smaller than the predetermined event finishing number information.

### Advantageous Effects

As described above, according to the present invention, in the online game, the item is provided when executing a certain item required in the event, thereby inducing game joining of the user.

### DESCRIPTION OF THE DRAWINGS

FIG. 1 is a flowchart of a method for providing an item according to joining an event in an online game according to an exemplary embodiment of the present invention.

FIG. 2 is a flowchart of a method for achieving an event according to an event kind in FIG. 1.

FIG. 3 is a flowchart showing an operation of a method in which an event is not achieved along with FIG. 1.

FIG. 4 is a flowchart showing a method of initializing an event joining number due to a shortage of an event achieving number along with FIG. 1.

FIG. 5 is a flowchart of a method for providing an item according to joining an event in another online game according to an exemplary embodiment of the present invention.

FIG. 6 is a diagram of a server for providing an item according to joining an event in an online game according to an exemplary embodiment of the present invention.

FIG. 7 to FIG. 11 show examples displayed in a screen of a user terminal according to realization of each exemplary embodiment of the present invention.

### MODE FOR INVENTION

Hereinafter, a method of providing an item and a server according to joining an event in an online game according to an exemplary embodiment of the present invention will be described with reference to accompanying drawings.

In the following description, in order to clearly understand the present invention, description of a known technology regarding a characteristic of the present invention will be omitted. It is obvious that the following exemplary embodiment is a detailed description which is provided for better understanding of the present invention, and does not limit the scope of the present invention. Therefore, an equivalent invention which performs the same function as the present invention may also be covered by the scope of the present invention.

In the following description, like reference numerals designate like elements having the same configurations, and redundant description and description of a known technology will be omitted.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer that users access to use game contents. In the case of a game which has a small capacity or a small number of users, a plurality of game programs may be operated by one game server. Further, in the case of a game which has a large capacity or a large number of real time accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game on the game. The online game also indicates a game various kinds of items in the game can be bought to play the game more smoothly.

Also, various community systems may be used in the online game in the present invention. For example, a guild or a clan of the online game may be formed. These concepts mean that the users using the online game are gathered and form one group to organize the groups. Each group may increase fame of the guild or the clan according to a number of users or a lever of characters of the users, and thereby the users may use various benefits in the game. For example, if the fame of the guild or the clan is increased, a display on a game screen of the character may be changed (e.g., an effect that a color of a name of the displayed character is changed), or the benefit of using the item and a village may be enjoyed in the game.

Also, the community system available in the online game has a party play. The party play as the group in the game play is realized through a requirement, an invitation, and an acceptance between the users who may use an independent chatting system between the organized party members and may use a certain display capable of identifying the party members on the game screen.

The party play as the group on the game play realized through a requirement, an invitation, and an acceptance between the users may use an independent chatting system between the organized party members, and may use a certain display capable of identifying the party members on the game screen. A sharing method may also be set by respectively owning the result contents and distributing at a least portion of the result contents to other characters.

In the present invention, the result contents means all contents capable of being obtained by the character of the play result users in the play of the game. For example, in a case of a shooting game, the experience value and the cyber money that are obtained when finishing one game may be included in the result contents, and in a case of a sports game, the experience value and the cyber money that are obtained when finishing one game may be the result contents. In the case of the role playing game, the experience value and the reward cyber money obtained when completing a certain quest or killing monsters may be the result contents.

When the character of the user in the online game obtains the certain result contents, all result contents are basically included to the character of the user. Also, when they are included to the party play or the guild or clan, at least a portion of the result contents acquired by the user may be distributed to the character of the other users included the party, the guild, or the clan.

Herein, an item indicates all data that can give assistance to playing the game and can be generally understood as an item in the game. For example, in a role playing game, an item for further increasing an experience level obtained when a character of a user subdues a monster, an item for changing the appearance of the character, and the like may correspond to the items in the present invention.

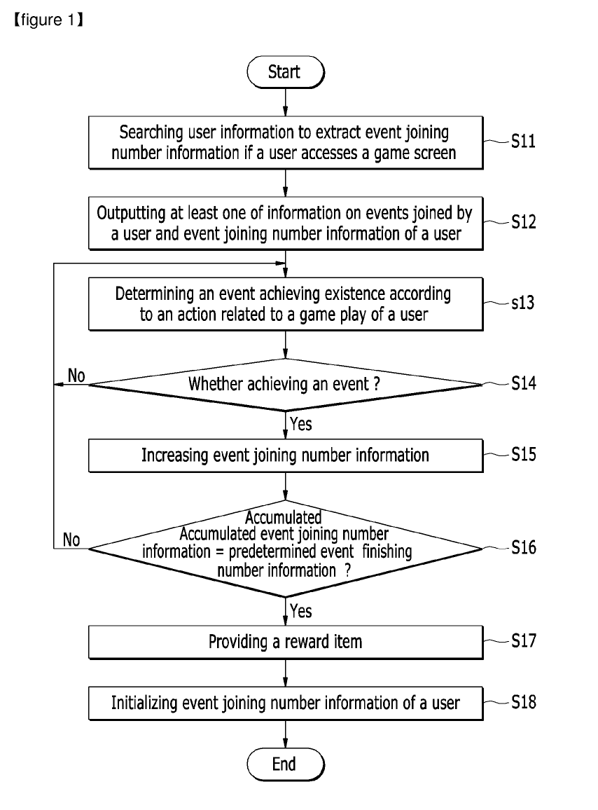

FIG. 1 is a flowchart of a method for providing an item according to joining an event in an online game according to an exemplary embodiment of the present invention.

Referring to FIG. 1, if a user accesses a game screen, a game management server searches user information stored therein to extract event number information regarding events the user joins (S11).

Next, the game management server outputs the information on events joined by the user, that is, outputs at least any one of event information including an event kind/an event execution period/a reward item when the user joins the event and the event joining number information of the user (S12). The game management server outputs each event joining number information according to the kind of the event. As the event kind provided by the game management server, there are an attendance event, a single play mode event, and a multi-play mode event.

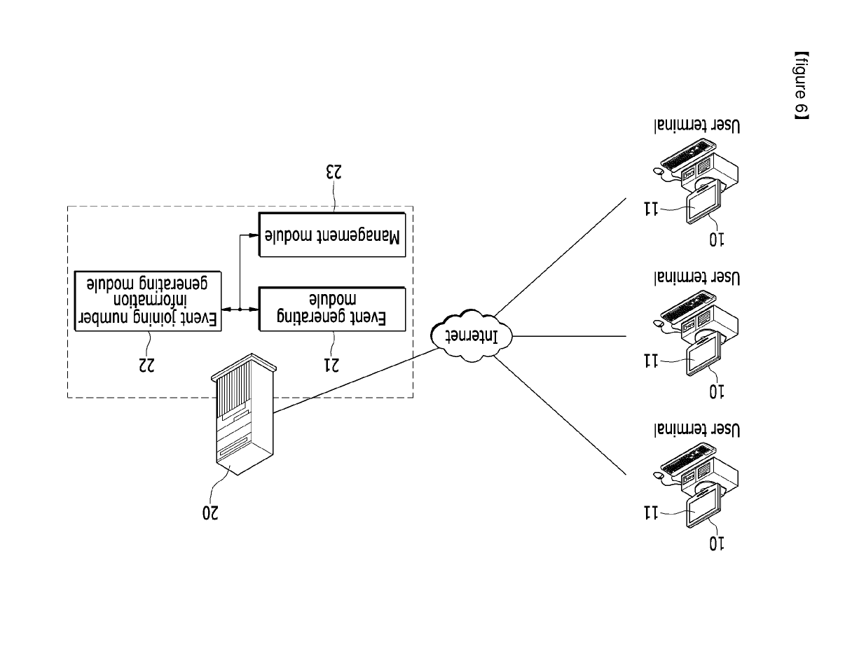

FIG. 7 shows event joining number information for an attendance event. In the event joining number information for the attendance event shown in FIG. 7, the event execution period is set from Nov. 1, 2011 to Nov. 10, 2011, and a reward item A and a joining information of the user (YY) are displayed together. This attendance event may increase the event joining number by only once game access a day within the event execution period.

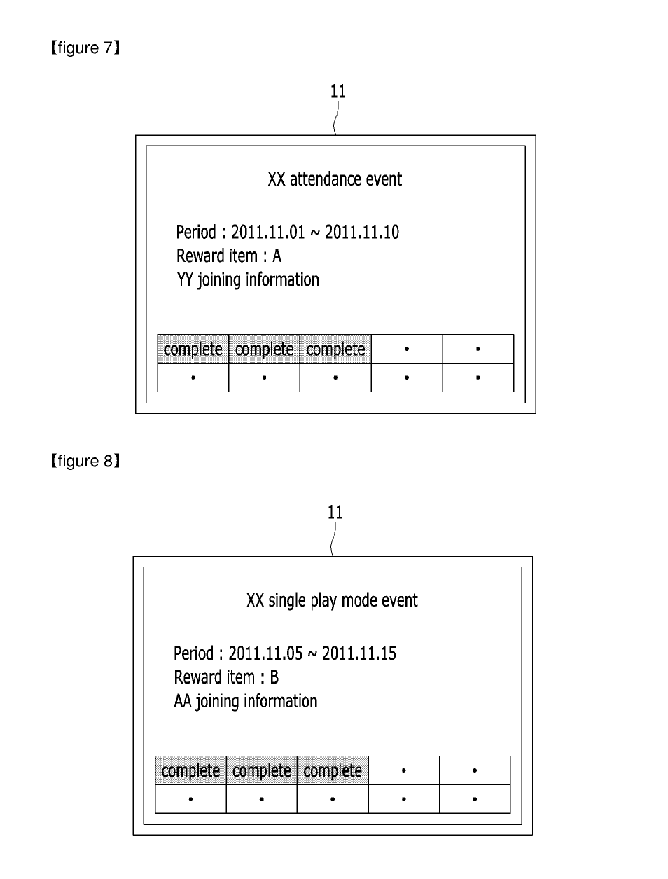

FIG. 8 shows the event joining number information for the single play mode event. Here, the single play mode is a game mode in which the team operated by the user plays the game with at least one opposing team operated by artificial intelligence of a computer. In the event joining number information for the single play mode event shown in FIG. 8, the event execution period is set from Nov. 5, 2011 to Nov. 15, 2011, and the reward item B and the joining information of the user AA are displayed together. For example, this single play mode event may increase the event joining number when the play is normally finished once a day within the event executing period, or the game is executed by using a simulation item.

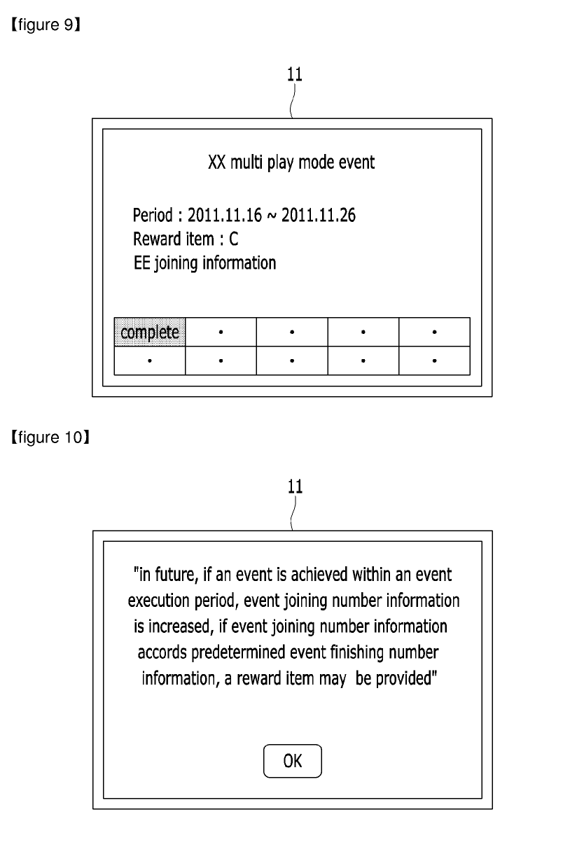

FIG. 9 shows the event joining number information for the multi-play mode event. Here, the multi-play mode is the game mode in which the team operated by the user plays the game with at least one opposing team operated by other users. In the event joining number information for the single play mode event shown in FIG. 9, the event execution period is set from Nov. 16, 2011 to Nov. 26, 2011, and the reward item C and the joining information of the user EE are displayed together. For example, this multi-play mode event may increase the event joining number when the play is normally finished once a day within the event execution period.

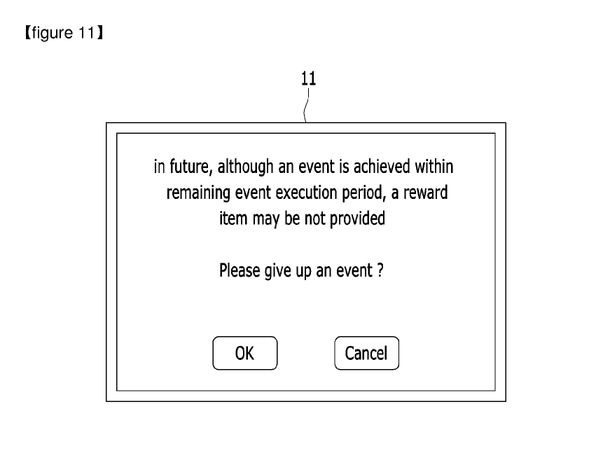

Also, while the game management server outputs the event joining number information of the user, as shown in FIG. 10, if the event is achieved within the event execution period in the future, the event joining number information is increased, and if the event joining number information accords with predetermined event finishing number information, a message window of a content that states that the reward item is provided is output to induce the game access of the user.

After at least one of the event-joined information of the user and the event joining number information of the user is output, the game management server determines an event achieving existence according to an action related to gameplay of the user within the event execution period S13.

As the determining result of the game management server, when the user achieves the event according to the action related to the gameplay (S14), the corresponding event joining number information is increased (S15). The user may achieve a plurality of events according to the event period and the kind, and the game management server increases the event joining number information corresponding to the event achieved by the user.

Next, the game management server determines whether the accumulated event joining number information of the user is the same as the predetermined event finishing number information (S16), and the reward item is provided when the accumulated event joining number information of the user is the same as the predetermined event finishing number information (S17). For example, in the case of the attendance event as shown in FIG. 7, as the determining result of the game management server, if the accumulated attendance event joining number information of the user is the same as the predetermined attendance event finishing number information (e.g., 10), the reward item A is provided. For example, in the case of the single play mode event as shown in FIG. 8, as the determining result of the game management server, the accumulated single play mode event joining number information of the user is the same as the predetermined event finishing number information (e.g., 7), the reward item B is provided. For example, in the case of the multi-play mode event as shown in FIG. 9, as the determining result of the game management server, if the accumulated multi-play mode event joining number information of the user is the same as the predetermined multi-play event finishing number information (e.g., 5), the reward item C is provided.

When the event execution period is finished or the user is provided with the reward item, the game management server initializes the event joining number information of the user S18.

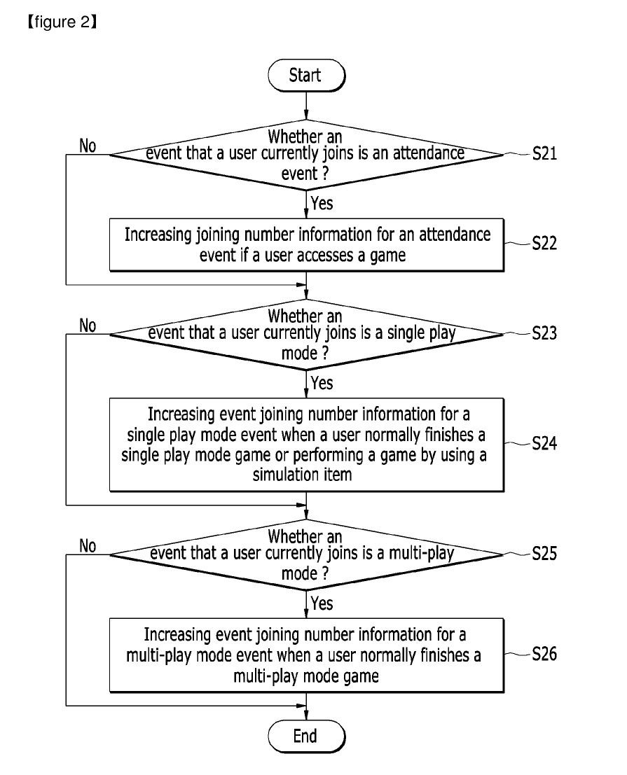

FIG. 2 is a flowchart showing a method of achieving an event according to an event kind. Referring to FIG. 2, as the searching result of the game management server, when the event in which the user is currently joined is the attendance event (S21), if the user accesses the game, the game management server increases the event joining number information for the attendance event (S22).

As the searching result of the game management server, when the event in which the user is currently joined is the single play mode event (S23), in the case in which the user normally finishes the single play mode game or performs the game by using the simulation item, the game management server includes the event joining number information for the single play mode event (S24).

As the searching result of the game management server, when the event in which the user is currently joined is the multi-play mode event (S25), in the case in which the user normally finishes the multi-play mode game, the game management server increases the event joining number information for the multi-play mode event (S26).

The user may achieve a plurality of events according to the event period and the kind, and the game management server may increase the event joining number information corresponding to the event achieved by the user.

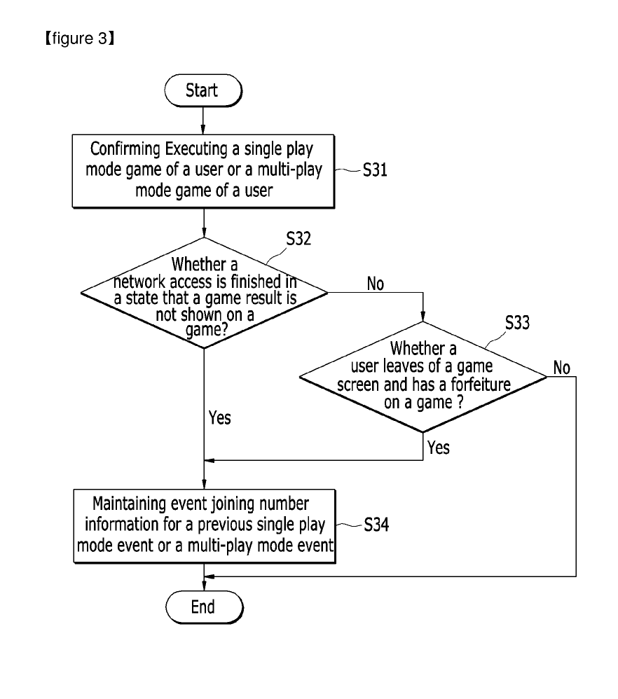

FIG. 3 is a flowchart showing an operation of a method that an event is not achieved along with FIG. 1. Referring to FIG. 3, the game management server confirms whether the user executes the single play mode or the multi-play mode (S31).

Next, while executing the single play mode game or the multi-play mode game, when the network access is finished in a state that the game result is not shown (S32) or the user leaves the game screen and then has a forfeiture while executing the game (S33), the game management server does not include the event joining number information and maintains the previous information (S34).

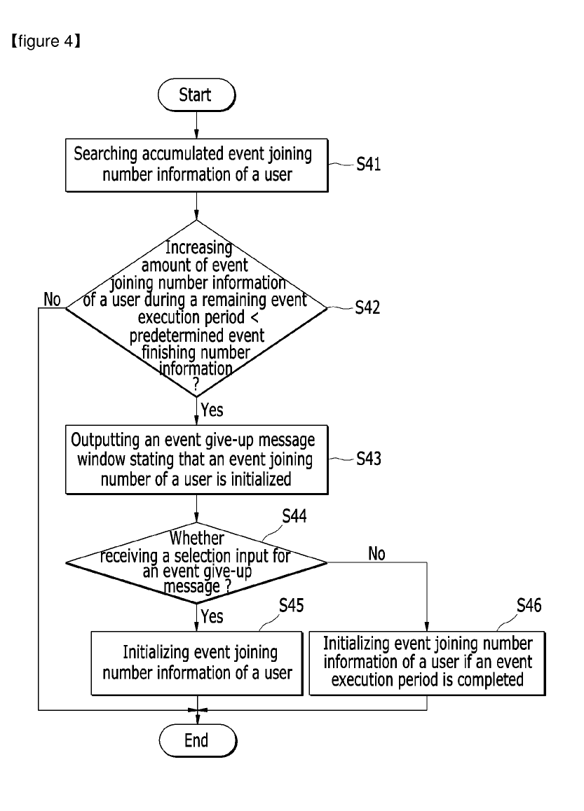

FIG. 4 is a flowchart showing a method of initializing an event joining number due to a shortage of an event achieving number, along with FIG. 1. Referring to FIG. 4, the game management server confirms the accumulated event joining number information of the user (S41).

As the confirmation result of the game management server, although the user increases the event joining number information during the remaining event execution period, when the event joining number information does not reach the predetermined event finishing number information (S42), an event give-up message window stating that the event joining number of the user is initialized is output (S43). FIG. 11 shows content of the event give-up message window output to the terminal of the user by the game management server. In the corresponding message window, although the event is achieved during the remaining event execution period in the future, since the reward item may not be provided, whether the event is given up is shown.

Next, the game management server determines whether a selection input for the event give-up message of the user is received (S44), when the selection input for the event give-up message of the user is received, the event joining number information of the user is initialized (S45).

In contrast, when the selection input for the event give-up message of the user is not received, the game management server initializes the event joining number information of the user if the event execution period is completed (S46).

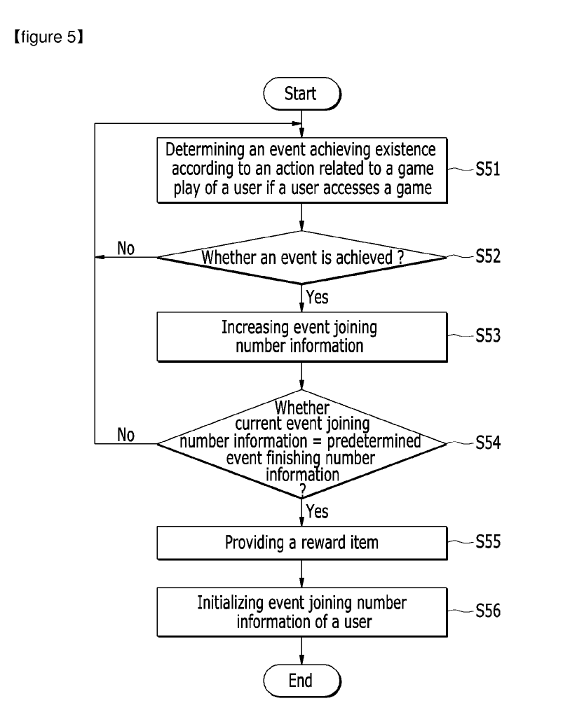

FIG. 5 is a flowchart of a method for providing an item according to event joining in another online game according to an exemplary embodiment of the present invention.

Referring to FIG. 5, if the user accesses the game within the predetermined event execution period, the game management server determines the event achieving existence according to the action related to the game play of the user (S51). The game management server sets the kind/event execution period/reward item of the event and determines the event achieving existence according to the action related to the game play of the user. The setting of the game management server was previously described such that it is omitted here.

As the determining result of the game management server, when the user achieves the event according to the play of the game (S52), the corresponding event joining number information is increased (S53).

Next, the game management server determines whether the accumulated event joining number information of the user is the same as the predetermined event finishing number information (S54), and if the accumulated event joining number information of the user is the same as the predetermined event finishing number information, the reward item is provided (S55).

When the event execution period is finished or the user receives the reward item, the game management server initializes the event joining number information of the user (S56). The detailed description related to FIG. 5 was previously described such that the description thereof is omitted here.

FIG. 6 is a diagram of a server for providing an item according to event joining in an online game according to an exemplary embodiment of the present invention, wherein the server includes a user terminal 10 (including a screen 11) and a game management server 20, and the game management server 20 includes an event generating module 21, an event joining number information generating module 22, and a management module 23.

If the user executes the predetermined action related to the game play, the event generating module 21 generates the event including the event kind, the event execution period, and the reward item for rewarding the item providing. The event generating module 21 may generate at least one among the attendance event increasing the event joining number information if the user accesses the game screen, the single play mode event increasing the event joining number information when the single play mode in which the team operated by the user plays at least one opposing team operated by the artificial intelligence of the computer is normally finished, or the multi-play mode event increasing the event joining number information when the multi-play mode in which the team operated by the user plays at least one opposing team operated by other users is normally finished.

The event joining number information generating module 22 generates the event joining number information including the event kind to which the user joins, the event execution period, the reward item, and the event achieving number. The event joining number information generating module 22 outputs the different event joining number information according to the event kind generated by the event generating module 21. For example, the event joining number information generating module 22 generates the event joining number information for the attendance event, the event joining number information for the single play mode event, and the event joining number information for the multi-play mode event.

The management module 23 determines the event achieving existence according to the action related to the game play for the user during the event execution period, and increases the event joining number information when the user actives the event by executing the predetermined action. Next, the management module 23 provides the reward item when the accumulated event joining number information of the user is the same as the predetermined event finishing number information.

The management module 23 provides the reward item to the user and then initializes the event joining number information of the user.

Also, the management module 23 searches the accumulated event joining number information of the user, and when the event joining number information increasing amount to be achieved by the user within the remaining event execution period is smaller than the predetermined event finishing number information, the management module 23 outputs the message initializing the event joining number information of the user to induce the giving up of the event of the user.

The item providing method according to the event joining in the online game according to an exemplary embodiment of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services. In this respect, the team play controller method of the online game according to an exemplary embodiment of the present invention may be implemented by the applications (i.e., programs) which are basically installed or directly installed by the user in the terminal and may be recorded in a computer readable recording medium of the terminal, and the like.

The programs are recorded in the computer readable recording medium and are executed by the computer, such that the above-mentioned functions may be executed.

As described above, in order for the computer to read the programs recorded in the recording medium and execute the item providing method according to the event joining in the online game in accordance with the exemplary embodiments of the present invention, the above-mentioned programs may include codes which are coded with computer languages such as C, C++, JAVA, machine language, and the like which may be read by a processor (CPU) of the computer.

The code may include a function code associated with a function defining the above-mentioned functions and may also include an execution procedure related control code required for the processor of the computer to execute the above-mentioned functions according to a predetermined procedure.

In addition, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

In addition, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus storing and executing a computer readable code by a distributed manner may be used. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the item providing method according to the event joining in the online game in accordance with the exemplary embodiments of the present invention, may be a storage medium (for example, a hard disk and the like) included in an application store server or an application providing server such as a web server associated with applications or corresponding services, and the like, or the application providing server itself.

A computer, which may read a recording medium recorded with applications that are programs for executing the item providing method according to the event joining in the online game in accordance with the exemplary embodiments of the present invention, may include not only a general PC such as a typical desktop and a laptop but also a mobile terminal such as a smart phone, a tablet PC, a personal digital assistant (PDA), and a mobile communication terminal, and is to be construed as all the computable devices.

When a computer, which may read a recording medium recorded with applications that are programs for executing the item providing method according to the event joining in the online game in accordance with the exemplary embodiments of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more components without departing from the scope of the present invention. In addition, although each of all the components may be implemented by one independent hardware unit, some or all of the respective components which are selectively combined with each other may be implemented by a computer program having a program module performing some or all of functions combined with each other in one or plural hardware units. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

In addition, it will be further understood that the terms “comprises” or “have” used in this specification may include the corresponding components unless explicitly described to the contrary and therefore, do not preclude other components but may further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as having the same meanings as those within a context of the related art and should not be interpreted as ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted that all spirits equivalent to the following claims fall within the scope of the present invention.

1. A method for providing an item according to event joining in an online game through a game management server, comprising:
increasing joining number information of the event by determining whether the event is achieved according to an action related to game play of a user during a predetermined event execution period when the user executes a predetermined action satisfying a condition achieving the event; and
providing a reward item when accumulated event joining number information of the user is predetermined event finishing number information.

2. The method of claim 1, wherein
the increasing of the event joining number information increases different event joining number information according to a kind of the event.

3. The method of claim 2, wherein
the kind of the event may be at least one among an attendance event increasing the event joining number information if the user accesses the game screen, a single play mode event increasing the event joining number information when a single play mode in which a team operated by the user plays at least one opposing team operated with artificial intelligence of a computer is normally finished, or a multi-play mode event increasing the event joining number information when the multi-play mode in which the team operated by the user plays at least one opposing team operated by other users is normally finished.

4. The method of claim 3, wherein
the increasing of the event joining number information maintains the event joining number information in one case among a case that the game result screen is not output, a case that any one user finishes the game in the games, and a case that a network access of any one user is finished in the game when executing the single play mode event or the multi-play mode event.

5. The method of claim 1, wherein
the increasing of the event joining number information includes:
outputting the event joining number information to the user terminal when the user executes the predetermined action; and
increasing the event joining number information when receiving a selection input for a region in which the event joining number information is displayed from the user terminal.

6. The method of claim 1, further comprising,
after providing the reward item,
initializing the event joining number information of the user.

7. The method of claim 1, further comprising
initializing the event joining number information of the user by searching the accumulated event joining number information of the user when the event joining number information increasing amount to be achieved by the user within the remaining event execution period is smaller than the predetermined event finishing number information.

8. The method of claim 1, further comprising,
before increasing the event joining number information,
extracting the event joining number information of the user by searching the information of the user when the user accesses the game.

9. The method of claim 1, further comprising,
before increasing the event joining number information,
outputting at least one of information of the event joined by the user and the event joining number information of the user to the user terminal of the user.

10. A server providing an item according to event joining in an online game, comprising:
an event generating module generating the event providing and rewarding an item if a predetermined action is executed according to an action related to a game play of the user;
an event joining number information generating module generating a kind of the event joined by the user and the event joining number information of the user; and
a management module determining the event achieving existence according to an action related to a game play of the user within an execution period of the predetermined event to increase the event joining number information when the user executes a predetermined action satisfying the condition achieving the event, and to provide a reward item when the accumulated event joining number information of the user is the same as predetermined event finishing number information.

11. The sever of claim 10, wherein
the event generating module generates any one among an attendance event increasing the event joining number information if the user accesses the game screen, a single play mode event increasing the event joining number information when the single play mode in which a team operated by the user plays at least one opposing team operated with artificial intelligence of a computer is normally finished, or the multi-play mode event increasing the event joining number information when the multi-play mode in which the team operated by the user plays at least one opposing team operated by other users is normally finished.

12. The server of claim 10, wherein
the event joining number information generating module outputs different event joining number information according to a kind of the event.

13. The server of claim 10, wherein
the management module initializes the event joining number information of the user after providing the reward item.

14. The server of claim 10, wherein
the management module initializes the event joining number information of the user by searching the accumulated event joining number information of the user when the event joining number information increasing amount to be achieved by the user within the remaining event execution period is smaller than the predetermined event finishing number information.

15. A program recording medium for realizing a method providing an item according to event joining in an online game through a game management server, comprising:
increasing joining number information of the event by determining whether the event is achieved according to an action related to a game play of a user during a predetermined event execution period when the user executes a predetermined action satisfying a condition achieving the event; and
providing a reward item when accumulated event joining number information of the user is predetermined event finishing number information.
